(19) United States
(12) Patent Application Publication
(10) Pub. No.: US 2025/0235729 A1
(43) Pub. Date: Jul. 24, 2025

(54) FIREFIGHTING CONNECTOR ASSEMBLY WITH GUIDE FUNCTION

(71) Applicant: Industry-Academic Corporation Foundation, Kunsan National University, Gunsan-si (KR)

(72) Inventor: Hie Chan KANG, Gunsan-si (KR)

(21) Appl. No.: 19/033,763

(22) Filed: Jan. 22, 2025

(30) Foreign Application Priority Data
Jan. 23, 2024 (KR) 10-2024-0009976

(51) Int. Cl. A62C 3/16; A62C 3/08; B60Q 1/52; B60Q 9/00

(52) U.S. Cl. CPC A62C 3/16; A62C 3/08; B60Q 1/52; B60Q 9/00

(57) ABSTRACT

The present disclosure includes a guide light unit which is provided on a housing side having a battery of a transport device including an electric vehicle and Urban Air Mobility (UAM) accommodated therein, clearly guides a firefighting water inlet through which firefighting water is able to be injected toward the battery side to prevent a fire of the battery or a fire, is disposed adjacent to the firefighting water inlet, and includes light sources; and a controller which generates a control signal so that a location of the firefighting water inlet and a state of the battery are able to be guided and the light sources each are able to emit light on the basis of the control signal.

### CROSS-REFERENCE TO RELATED APPLICATIONS

This application claims the priority of the Korean Patent Applications NO 10-2024-0009976, filed on Jan. 23, 2024, in the Korean Intellectual Property Office. The entire disclosures of all these applications are hereby incorporated by reference.

### BACKGROUND

### 1. Field

The present disclosure relates to a firefighting connector assembly with a guide function, and more particularly to a firefighting connector assembly with a guide function having an improved structure in which a location of a firefighting water inlet through which firefighting water is able to be supplied toward a battery side to prevent battery firing or firing of a transport device including an electric vehicle and Urban Air Mobility (UAM) is guided, in which firefighting water is able to be rapidly injected toward a battery side, and in which an existing fire hose connected to a fireplug or a fire engine is able to clearly and easily communicate with a firefighting water inlet from a distance.

### 2. Description of the Related Art

In recent years, in the international community, due to the strengthening of exhaust gas regulations caused due to the worsening of global warming and changes in the public's awareness of environmental issues, the market share of internal combustion engine vehicles which have dominated the existing vehicle market is gradually decreasing, while the market share of electric vehicles is increasing. According to a survey by the International Energy Agency (IEA), the market share of electric vehicles grew rapidly in 2020. Here, as the electric vehicle market expands, electric vehicle fires are emerging as major issues.

The extinguishing of the fires of electric vehicles using existing fire suppression facilities is difficult due to a mechanical structure and a compositional material that are different from those of internal combustion engine vehicles. Thus, the techniques for extinguishing fires in the event of a fire in an electric vehicle are being developed in various ways. As methods (techniques) for suppressing a fire of an electric vehicle in the related art, there are a method in which a water-based fire extinguisher is used, a method in which a suffocating cover is used, a simple tank method in which fire suppression is allowed by towing an electric vehicle which has caught fire and then submerging the electric vehicle in a tank including a fluid, and the like.

The most commonly used device of extinguishing electric vehicle fires today are fire extinguishing tanks and sprinkler nozzles. Firefighting water tanks take a relatively long time to extinguish, require a large amount of firefighting water, space, and several firefighters, and are difficult to block inhaling hazardous gases. In addition, fires are difficult to extinguish in vehicles with batteries installed on the ceiling such as electric buses. In the case of a sprinkler nozzle, the housing which accommodates the battery at the bottom of the electric vehicle is able to be cooled to reduce only the external thermal resistance of the housing.

In this way, a method for suppress a fire of an electric vehicle in the related art has the issues that it is difficult to effectively suppress the fire, it is difficult to clearly and easily connect the fire hose connected to the fire engine or fireplug to the electric vehicle and it takes a long time to suppress the fire while a large amount of firefighting water is required to suppress the fire.

As the related art, there is Registered Korean Patent No. 10-2407326.

### SUMMARY

The present disclosure was created to solve the above matters, and the present disclosure is for the purpose of providing a firefighting connector assembly with a guide function which clearly guides a location of a firefighting water inlet through which firefighting water is able to be supplied toward a battery side of a transport device including an electric vehicle and Urban Air Mobility (UAM), in which firefighting water is able to be rapidly injected toward the battery side, and in which an existing fire hose connected to a fireplug or a fire engine is able to clearly and easily communicate with the firefighting water inlet from a distance.

The solutions of the present disclosure are not limited to those described above and other solutions not described may be clearly understood by those skilled in the art from the description which will be described below.

A firefighting connector assembly with a guide function according the present disclosure to achieve the above purpose includes a guide light unit which is provided on a housing side having a battery of a transport device including an electric vehicle and UAM accommodated therein, clearly guides a firefighting water inlet through which firefighting water is able to be injected toward the battery side to prevent a fire of the battery or a fire, is disposed adjacent to the firefighting water inlet, and includes light sources; and a controller which generates a control signal so that a location of the firefighting water inlet and a state of the battery are able to be guided and the light sources each are able to emit light on the basis of the control signal.

It is preferable that the present disclosure further include a sensor which detects a temperature of the battery and then transmits a detection signal to the controller.

The guide light unit may receive, when the controller determines that the temperature of the battery is outside of a preset reference temperature range on the basis of the detection signal, a control signal regarding a caution signal from the controller and emit light corresponding to the attention signal on the basis of the control signal.

It is preferable that the guide light unit receive, when the controller receive an airbag activation signal of the transport device, a control signal regarding an alarm signal from the controller and emit light corresponding to the alarm signal on the basis of the control signal.

The guide light unit may have a structure in which it surrounds the firefighting water inlet and may be formed in a shape of a circular ring or a polygonal ring.

It is preferable that the firefighting water inlet include a quick plug clamp which is inserted into an insertion groove part formed along a circumference on an outside of the quick plug hose part so that easy connection with the quick plug hose part is possible.

A push-to-open button which includes a push rod provided inside the housing and opens an opening port by pushing a cover member in response to a pressure applied to the cover member may be installed in the housing.

It is preferable that the firefighting water inlet include an inlet screw connection part which has the same specifications as a fire hose and a fire standard screw and be able to be directly connected to a fire hose connection part.

The guide light unit may provide guidance regarding a location of the firefighting water inlet by emitting light through at least one light source among charging light, turn signal light, brake light, and fog light adjacent to the firefighting water inlet, thereby guiding the location of the firefighting water inlet and a level of danger.

A firefighting connector assembly with a guide function according to the present disclosure having the configuration as described above has the effects in which it is configured so that the guide light unit surrounds the opening port of the housing in which the firefighting water inlet is exposed to the outside, in the case of battery temperature surge or fire, the guide light unit flashes in accordance with the control signal of the controller, allowing the location of the firefighting water inlet to be identified from a distance, and thus the location of the firefighting water inlet in the transport device including an electric vehicle and UAM is able to be clearly guided, firefighting water is able to be rapidly injected toward the battery side, and an existing fire hose connected to a fireplug or fire engine is able to clearly and easily communicate with a firefighting water inlet from a distance.

The effects of the present disclosure are not limited to those described above and other effects not described will be clearly understood by those skilled in the art from the description which will be described below.

### BRIEF DESCRIPTION OF THE DRAWINGS

FIGS. 1 and 2 are diagrams showing a state in which a firefighting connector assembly with a guide function according to an example embodiment of the present disclosure is connected to a firefighting water inlet of an electric vehicle and Urban Air Mobility (UAM).

FIG. 3 is an enlarged view of part III of FIG. 2.

FIG. 4 is a perspective view of an example embodiment of the present disclosure.

FIG. 5 is a diagram for explaining a guide light unit employed in an example embodiment of the present disclosure.

FIG. 6(a) and FIG. 6(b) are a diagram for explaining a quick plug hose part and a firefighting water inlet employed in an example embodiment of the present disclosure.

FIG. 7 is a diagram for explaining a fire connector connected to an inlet screw connection part employed in an example embodiment of the present disclosure.

FIG. 8 is a diagram for explaining a firefighting connector assembly with a guide function according to another example embodiment of the present disclosure.

### DETAILED DESCRIPTION

In order to clarify the understanding of the present disclosure in the following explanation, the description of the publicly known technique regarding the features of the present disclosure will be omitted. The following examples are provided as detailed explanations to aid understanding of the present disclosure and need not to be construed as limiting the scope of the rights of the present disclosure. Therefore, an equivalent invention which performs the same function as the present disclosure will also fall within the scope of the rights of the present disclosure.

Furthermore, in the following description, the same identification symbol means the same configuration and unnecessary redundant descriptions and descriptions of known techniques are omitted. In addition, the description of each example embodiment of the present disclosure which will be described below and that are same as the description of the technique serving as the background for the above invention will also be omitted.

A firefighting connector assembly with a guide function according to an example embodiment of the present disclosure will be described in detail below with reference to the attached drawings.

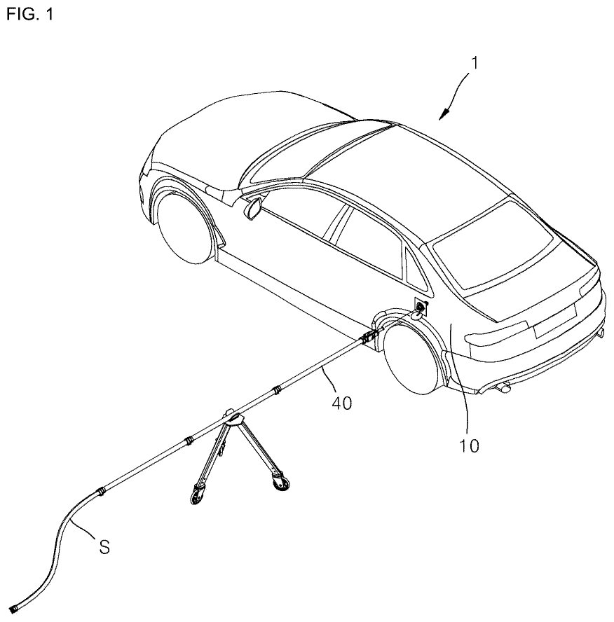

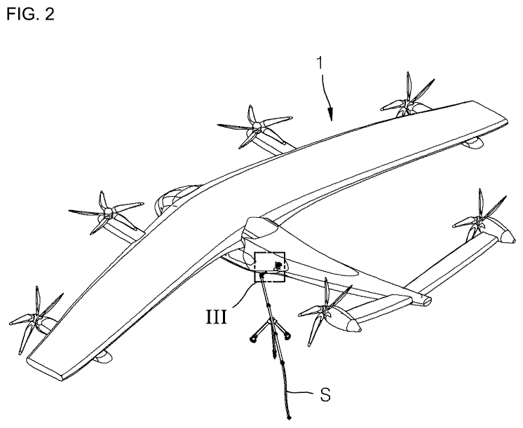

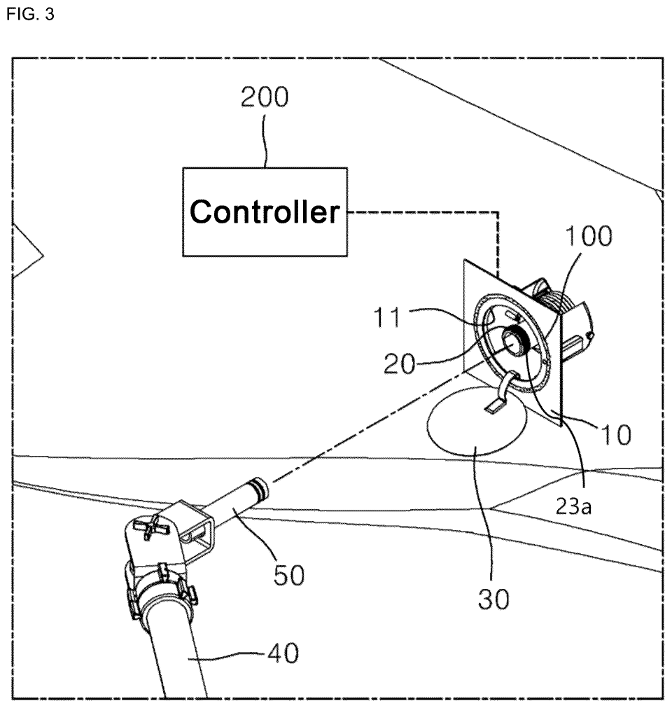

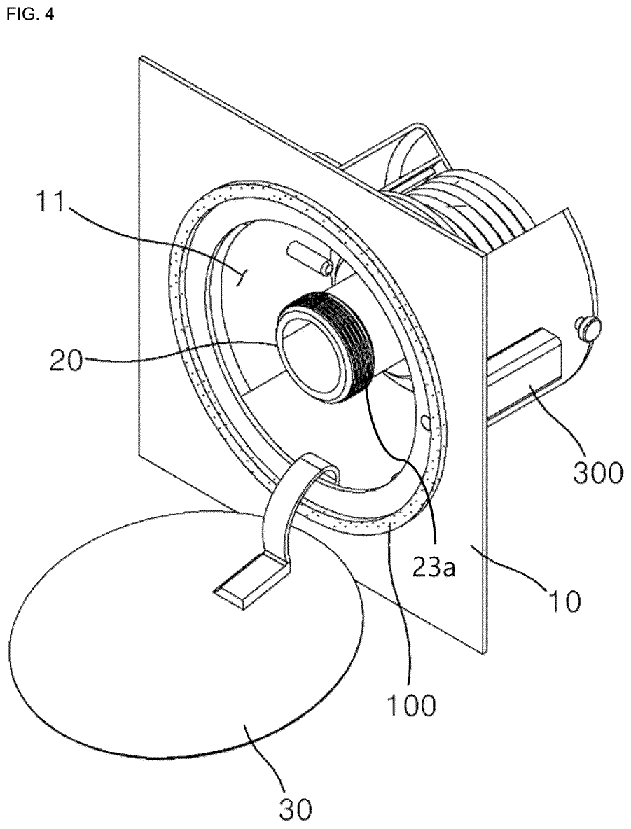

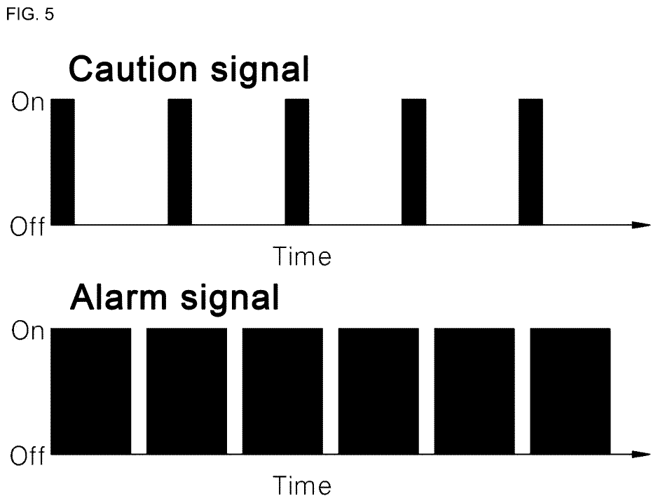

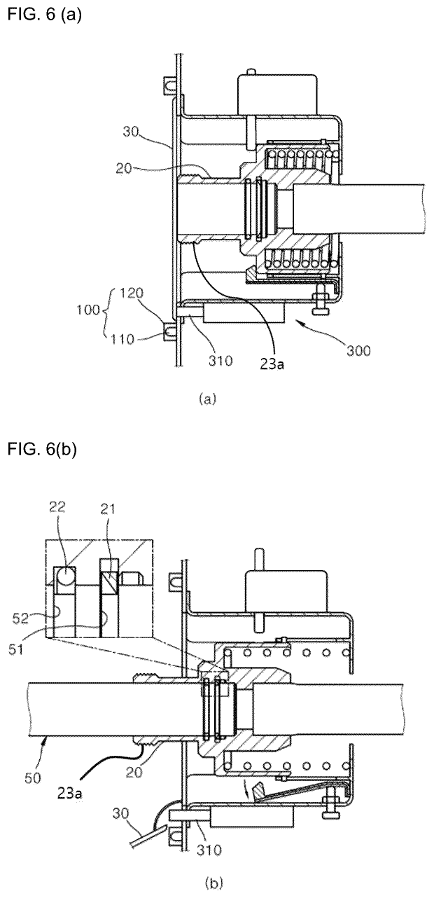

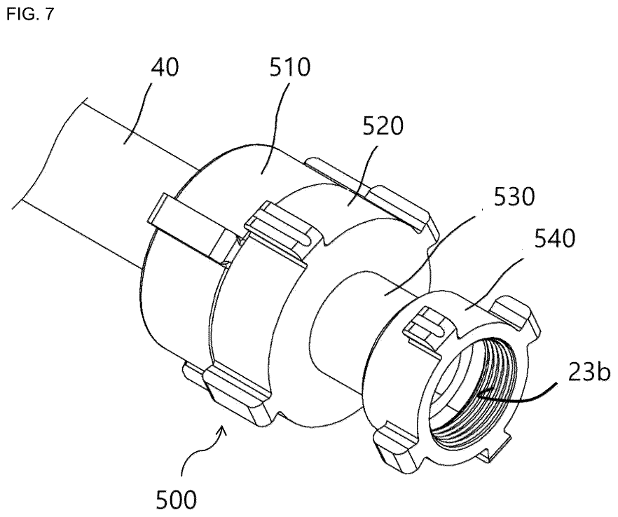

FIG. 1 and FIG. 2 are diagrams showing a state in which a firefighting connector assembly with a guide function according to an example embodiment of the present disclosure is connected to a firefighting water inlet of an electric vehicle and Urban Air Mobility (UAM), FIG. 3 is an enlarged view of part III of FIG. 2, FIG. 4 is a perspective view of an example embodiment of the present disclosure, FIG. 5 is a diagram for explaining a guide light unit employed in an example embodiment of the present disclosure, FIG. 6 is a diagram for explaining a quick plug hose part and a firefighting water inlet employed in an example embodiment of the present disclosure, and FIG. 7 is a diagram for explaining a fire connector connected to an inlet screw connection part employed in an example embodiment of the present disclosure.

As shown in FIG. 1 to FIG. 3, a firefighting connector assembly with a guide function according to an example embodiment of the present disclosure is provided on a housing 10 side having a battery of a transport device 1 including an electric vehicle and UAM accommodated therein, is configured to clearly guide a firefighting water inlet 20 through which firefighting water may be injected toward the battery side, and is configured to include a guide light unit 100 and a controller 200.

The guide light unit 100 is operated on the basis of a control signal of a controller as shown in FIG. 3 and FIG. 4 and may display a temperature state of the battery externally by blinking the light on the basis of the control signal. The guide light unit 100 is formed in a form in which the firefighting water inlet 20 is exposed to the outside of the housing 10 and surrounds an opening port 11 of the housing 10 which is opened and closed by a cover member 40 and includes a plurality of light sources 110 which generate light on the basis of the control signal.

The guide light unit 100 flashes light thereof on the basis of the control signal in the event of a battery temperature surge or fire, thereby guiding firefighters, drivers, or firefighting assistants to the location of the firefighting water inlet 20 through which firefighting water is able to be supplied toward the battery side. For example, the guide light unit 100 may be driven to have different blinking states according to a rise in battery temperature and a blinking state according to a battery fire on the basis of the control signal.

The light sources 110 of the guide light unit 100 may include a circuit board (not shown) in which light emission is possible in accordance with the control signal and are disposed outside the housing 10 while being blocked from the outside using the protection case 120. The protection case 120 is made of a material which allows light to pass through and may prevent foreign substances from entering the light source.

The controller 200 generates a control signal in response to a change in battery temperature or a fire, transmits the control signal to the guide light unit 100, and controls the guide light unit 100 so that the light sources may emit light on the basis of the control signal. The controller 200 may be formed in various forms and may be installed inside the housing of the transport device. The controller 200 may set an operation state of the guide light unit 100 on the basis of a user's input signal and control the guide light unit 100 in accordance with the set state.

A firefighting connector assembly with a guide function according to an example embodiment of the present disclosure having such a configuration is configured so that the guide light unit 100 surrounds the opening port 11 of the housing exposing the firefighting water inlet 20 to the outside and has effects in which, when the temperature of the battery goes up or a fire occurs, the guide light unit flashes in accordance with the control signal of the controller, thereby enabling the location of the firefighting water inlet to be identified from a distance and clearly guiding the location of the firefighting water inlet in the transport device including electric vehicles and UAM, firefighting water is allowed to be rapidly injected toward the battery side, and an existing fire hose S connected to a fireplug or a fire engine may clearly and easily communicate with a firefighting water inlet from a distance.

The guide light unit 100 is intended to guide the location of the firefighting water inlet 20 of the firefighting water inlet from a distance. Thus, the guide function may be performed using a charging light, a turn signal light, a brake light, a fog light, or other light source adjacent to the firefighting water inlet.

This example embodiment may further include a sensor (not shown in the drawing). It is preferable that the sensor be configured to detect a temperature and a fire and may be installed at a location adjacent to the battery inside the housing of the transport device. In addition, the sensor may be installed in a location adjacent to the battery inside the housing of the transport device. The sensor detects the temperature of the battery and transmits a detection signal for the temperature to the controller.

The controller 200 receives a detection signal and determines whether the temperature of the battery is outside of a preset reference temperature range. When the controller determines that the battery temperature is outside the above-described reference temperature range (when it is determined that it corresponds to the battery danger temperature determined by the regulatory agency), it transmits a control signal regarding a caution signal to the guide light unit 100.

At this time, the guide light unit 100, on the basis of the control signal regarding a caution signal transmitted by the controller, emits light corresponding to the caution signal to inform the driver, the firefighter, and the firefighting assistant of the temperature state of the battery and guides the location of the firefighting water inlet 20 through which firefighting water is able to be injected into the battery side, thereby deriving the advantage of enabling rapid response and fire suppression.

The controller 200 may transmit a control signal regarding an alarm signal to the guide light unit 100 when an airbag activation signal of the transport device 1 is authorized from the control device of the transport device. At this time, the guide light unit 100 may emit light corresponding to an alarm signal on the basis of the control signal regarding the alarm signal authorized by the controller to alert the driver, the firefighter, and the firefighting assistant regarding the state of the battery.

For example, the caution signal may be in the form of a light flashing at 2-second intervals and the alarm signal may be in the form of a light flashing at 0.5-second intervals. On the other hand, the guide light unit 100 may include a speaker to display the caution signal and alarm signal as a sound and may also include a display window to display the signals as letters or shapes. The speaker or the display window may be provided on the outer surface of the housing and may be driven on the basis of the control signal from the controller (refer to FIG. 5).

It is preferable that the guide light unit 100 have a closed loop structure and is formed in the shape of a circular ring or a polygonal ring, as shown in FIG. 4. In this way, the guide light unit 100 may be formed in various ring shapes, thereby more effectively guiding the firefighting water inlet 20 through which firefighting water is able to be guided toward the battery side.

As shown in FIG. 6, the firefighting water inlet 20 employed in this embodiment is configured to have the quick plug hose part 50 connected to the fire hose S using an extension straight pipe part 40 and may further include a quick plug clamp 21. The quick plug clamp 21 is provided along the circumference on the inside of the firefighting water inlet 20, easy connection between the quick plug hose part and the firefighting water inlet from a distance is possible by inserting the quick plug hose part into an insertion groove part 51 formed on the outside of the quick plug hose part 50 during the insertion process, and the amount of firefighting water and the suppression time may be reduced at the time of suppressing a fire of a battery and the temperature of the battery may be effectively regulated.

The firefighting water inlet 20 includes an inlet screw connection part 23a that is the same as a fire hose and a fire standard screw so that, in the absence of the quick plug hose part 50, a firefighter may inject firefighting water from a fireplug or fire engine to a fire standard connector.

Here, it is preferable that the insertion groove part 51 be formed as a groove structure in the circumferential direction on the outside of the quick plug hose part 50. Furthermore, the quick plug hose part 50 may have a sealing groove part 52 located adjacent to the insertion groove part. The sealing groove part 52 prevents external leakage of firefighting water injected into the firefighting water inlet 50 via the quick plug hose part 50 from the fire hose by inserting a sealing member 22 provided circumferentially on the inner surface of the firefighting water inlet 20 during the process of fitting the quick plug hose part 50 into the firefighting water inlet 20, thereby reducing the amount of firefighting water used during fire suppression.

It is preferable to use a fire standard screw 25A, 40A, or 60A for the inlet screw connection part 23a of the firefighting water inlet 20 so that the firefighter may easily connect it without a separate auxiliary device.

An example embodiment may further include a push-to-open button 300, as shown in FIG. 6. The push-to-open button 300 is provided on the inside of the housing 10. In addition, when the quick plug hose part 50 applies a pressure to the cover member 30, in response to that pressure, a push rod 310 pushes the cover member 30 outward to open the opening port 11, thereby allowing the cover member 30 which is identified using the guide light unit 100 to be easily operated from a distance and a clear and easy connection of the quick plug hose part 50 and the firefighting water inlet 20 is allowed while clearly guiding the location of the firefighting water inlet 20 from a distance.

As shown in FIG. 7, the connection unit 500 is provided between the extension straight pipe part 40 and the inlet screw connection part 23a to connect the extension straight pipe part 40 and the inlet screw connection part 23a. The connection unit 500 is configured to include a standard connector 510, a communication connector 520, a tube part 530, a second communication connector 540, and a second communication connector screw part 23b.

The standard connector 510 of the connection unit 500 is connected to the end portion of the extension straight pipe part 40 and is connected to the communication connector 520. The communication connector 520 and the second communication connector 540 are installed so that fire hoses or the tube part 530 with different diameters may be connected without twisting. The second communication connector screw part 23b is connected to the inlet screw connection part 23a.

Common female and male screws in which fastening is possible are used for the second communication connector screw part 23b and the inlet screw connection part 23a. It is preferable to use the standard fire screws 25A, 40A, or 60A for the second communication connector screw part 23b and the inlet screw connection part 23a to standardize a firefighting apparatus.

The firefighting connector assembly with a guide function according to example embodiment of the present disclosure has been described above. The firefighting connector assembly with a guide function according to another example embodiment of the present disclosure is described below with reference to the attached drawings.

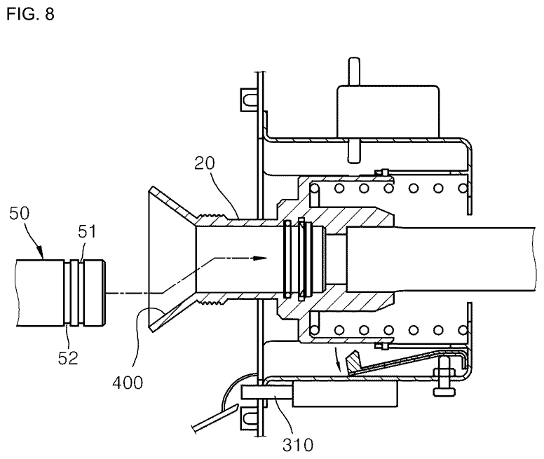

FIG. 8 is a diagram showing a firefighting connector assembly with a guide function according to another example embodiment of the present disclosure.

As shown in FIG. 8, this example embodiment is similar in most of a configuration thereof to the previously described example embodiment, but differs in that it further includes the guide plate 400.

That is to say, the guide plate 400 employed in this example embodiment is provided at the end portion of the firefighting water inlet 20 facing the outside of the housing 10 and is formed in a funnel shape with a diameter which gradually decreases in the direction in which the quick plug hose part 50 is fitted into the firefighting water inlet 20. The guide plate 400 may be formed so that a maximum diameter thereof is smaller than the diameter of the opening port 11 and a minimum diameter thereof is the same as the diameter of the firefighting water inlet 20.

The guide plate 400 is formed in a funnel shape at the end portion of the firefighting water inlet 20 and guides the quick plug hose part 50 to the firefighting water inlet side so that it may easily approach the firefighting water inlet 20 from a distance, and thus in the event of a fire in an electric vehicle or UAM, it is possible to clearly and easily inject firefighting water into the firefighting water inlet from a distance, shorten the fire suppression time, and achieve the advantage of effectively suppressing the fire.

Although various example embodiments of the present disclosure have been described, the example embodiments and the drawings attached to this specification only clearly illustrate a portion of the technical ideas included in the present disclosure and it is clear that all modifications and specific example embodiments which may be easily inferred by a person skilled in the art within the scope of the technical ideas included in the specification and the drawings of the present disclosure are included within the scope of the rights of the present disclosure.

### EXPLANATION OF REFERENCE NUMERALS

1 Transport device
10 Housing
11 Opening port
20 Firefighting water inlet
21 Quick plug clamp
22 Sealing member
23a Inlet screw connection part
23b Second communication connector screw part
30 Cover member
40 Extension straight pipe part
50 Quick plug hose part
51 Insertion groove part
52 Sealing groove part
100 Guide light unit
110 Light source
120 Protection case
200 Controller
300 Push-to-open button
400 Guide plate
500 Connection unit
510 Standard connector
520 Communication connector
530 Tube part
540 Second communication connector

What is claimed is:

1. A firefighting connector assembly with a guide function, comprising:
a guide light unit which is provided on a housing side having a battery of a transport device including an electric vehicle and Urban Air Mobility (UAM) accommodated therein, clearly guides a firefighting water inlet through which firefighting water is able to be injected toward the battery side to prevent a fire of the battery or a fire, is disposed adjacent to the firefighting water inlet, and includes light sources; and
a controller which generates a control signal so that a location of the firefighting water inlet and a state of the battery are able to be guided and the light sources each are able to emit light on the basis of the control signal.

2. The firefighting connector assembly with a guide function of claim 1, further comprising:
a sensor which detects a temperature of the battery and then transmits a detection signal to the controller,
wherein the guide light unit receives,
when the controller determines that the temperature of the battery is outside of a preset reference temperature range on the basis of the detection signal,
a control signal regarding a caution signal from the controller and emits light corresponding to the attention signal on the basis of the control signal.

3. The firefighting connector assembly with a guide function of claim 1, wherein the guide light unit receives, when the controller receive an airbag activation signal of the transport device, a control signal regarding an alarm signal from the controller and emits light corresponding to the alarm signal on the basis of the control signal.

4. The firefighting connector assembly with a guide function of claim 1, wherein the guide light unit has a structure in which it surrounds the firefighting water inlet and is formed in a shape of a circular ring or a polygonal ring.

5. The firefighting connector assembly with a guide function of claim 1, wherein the firefighting water inlet includes a quick plug clamp which is inserted into an insertion groove part formed along a circumference on an outside of the quick plug hose part so that easy connection with the quick plug hose part is possible.

6. The firefighting connector assembly with a guide function of claim 1, wherein a push-to-open button which includes a push rod provided inside the housing and opens an opening port by pushing a cover member in response to a pressure applied to the cover member is installed in the housing.

7. The firefighting connector assembly with a guide function of claim 1, wherein the firefighting water inlet includes an inlet screw connection part which has the same specifications as a fire hose and a fire standard screw and is able to be directly connected to a fire hose connection part.

8. The firefighting connector assembly with a guide function of claim 1, wherein the guide light unit provides guidance regarding a location of the firefighting water inlet by emitting light through at least one light source among charging light, turn signal light, brake light, and fog light adjacent to the firefighting water inlet, thereby guiding the location of the firefighting water inlet and a level of danger.
